(19) United States
(12) Patent Application Publication
(10) Pub. No.: US 2021/0372527 A1
(43) Pub. Date: Dec. 2, 2021

(54) INCREASED ROBUSTNESS OF CONTROL LINES AND TOOLS WITH EXPANDING COMPRESSION DEVICE

(71) Applicant: Halliburton Energy Services, Inc., Houston, TX (US)

(72) Inventors: Michael L. FRIPP, Carrollton, TX (US); Paul G. JAMES, Spring, TX (US); Matthew A. WILLOUGHBY, Plano, TX (US)

(21) Appl. No.: 16/884,743

(22) Filed: May 27, 2020

(51) Int. Cl. F16J 15/3284; E21B 19/16; E21B 17/042; F16L 15/04

(52) U.S. Cl. CPC F16J 15/3284; F16L 15/04; E21B 17/042; E21B 19/16

(57) ABSTRACT

A sealing device comprising an expanding metal provides for ongoing self-healing capability for use as a seal in conjunction with any downhole device or tool in wellbore applications. The sealing device may be a ferrule, or other type of compression device, that may be used for connecting one device to another device, such as a tube to a fitting, or a communication line to a downhole device. Wellbore fluids activate the expanding metal causing a leak to heal itself.

### TECHNICAL FIELD

This disclosure relates, in general, to an expanding metal used as a compression device and, in particular, to an expanding metal used as a compression device that reacts with a wellbore fluid to create a seal between different surfaces of one or more devices.

### BACKGROUND

Without limiting the scope of the present disclosure, its background will be described with reference to downhole devices that are used for, but limited to, preparing wells, measuring wells, post-production activity, or any device related to producing fluid from a hydrocarbon bearing subterranean formation, as an example.

Downhole devices including, for example, tubes, wires, conduits, cables, gauges, meters, sensors, tools, control lines, electric lines, optical lines, monitoring devices, valves, typically require some form of connection to another downhole device or component. Often this connection requires a seal component to resist intrusion of downhole fluids at the connection point into a downhole device.

The seal may be a flexible type seal often made from a plastic or rubber type component, perhaps some form of elastomer, or Teflon®. These types of flexible seals tend to degrade over time, loosing integrity. Occasionally, these seals may also be impaired by physical degradation, such as caused by downhole device movement or by vibrations. Moreover, these type of seals may lose sealing volume over time leading to seepage at the connection point. Further, these type of flexible seals may have a relatively low limit for accepting torque pressure such as when tightening a retaining mechanism, such as a threaded nut. Over torquing a retaining mechanism using this type of flexible seal can lead to early seal faults.

### BRIEF DESCRIPTION OF THE DRAWINGS

For a more complete understanding of the features and advantage of the present disclosure, reference is now made to the detailed description along with the accompanying figures in which corresponding numerals in the different figures refer to corresponding parts and in which:

FIG. 1 is an illustration of an example logging system employing compression devices, in accordance with principles of the present disclosure;

FIG. 2 is an illustration of an example setting tool employing a compression device, in accordance with principles of the present disclosure;

FIG. 3A is an illustration of example embodiment of a compression device, according to principles of the present disclosure;

FIG. 3B is an illustration of an example of the compression device of FIG. 3A with a coating applied, according to principles of the present disclosure;

FIG. 4A is an illustration of another example embodiment of a sealing device in a cut-away perspective, according to principles of the present disclosure;

FIG. 4B is an illustration of an example of the sealing device of FIG. 3A with a coating applied, according to principles of the present disclosure;

FIG. 4C is an illustration of an example of a sealing ring, according to principles of the present disclosure;

FIG. 4D is an illustration of an example of a segmented sealing ring, according to principles of the present disclosure;

FIG. 5A is an illustration of another example embodiment of a compression device, according to principles of the present disclosure; and

FIG. 5B is an illustration of an example of the compression device of FIG. 5A with a coating applied, according to principles of the present disclosure.

### DETAILED DESCRIPTION

While apparatuses, methods and embodiments are discussed in detail below, it should be appreciated that the present disclosure provides many applicable inventive concepts, which can be embodied in a wide variety of specific contexts. The examples herein are illustrative and do not delimit the scope of the present disclosure.

A wellbore is a hole that is drilled in a subterranean formation to aid in the exploration and recovery of natural resources, including oil and gas. A wellbore may be drilled along any given path, which in some cases is along a nominally straight and/or vertical wellbore path, and in other cases may follow a deviated path, such as in the deliberate steering of a borehole as it is drilled along a tortuous path through a formation to reach a target formation. The terms uphole and downhole are generally understood in the art with regard to the path of the wellbore. For example, in the absolute sense, uphole may refer to a location at or near the surface of a well site where drilling of the wellbore begins, and downhole may refer to a location within the drilled wellbore below the surface of the well site. In the relative sense, the terms uphole may refer to a direction toward or a position along the path of the wellbore nearer the beginning of the wellbore, and downhole may refer to a direction toward or a position further along the path of the wellbore.

The present disclosure is directed to various compression devices comprising an expanding metal that is a metal that chemically reacts when exposed to wellbore fluids containing water, or water-containing fluids that may be provided for operations such as hydraulic or control line fluids. Hydraulic or control line fluids may be provided from the surface. An expanding metal refers to any metal or combination of metals that react with a water-containing fluid and expands in volume. Examples include magnesium, aluminum, and calcium, as well as alloys of those metals. The volume of the expanding metal increases during a water-based chemical reaction. The water-based chemical reaction converts a metal or a metal oxide into a metal hydroxide where the metal hydroxide occupies more volume than the metal. This reaction creates an expanding seal when the compression device is used to secure interfaces between downhole devices while in a water environment, a ⁻water-hydrocarbon environment such as downhole in a wellbore, or involving fluids provided from the surface such as hydraulic or control line fluids. For example, the downhole devices may involve any tool, apparatus, connector, conduit, tube, pipe, or adaptor that requires a sealed connection while deployed downhole, The expanding metal enhances the sealing of a compression device or compression fitting.

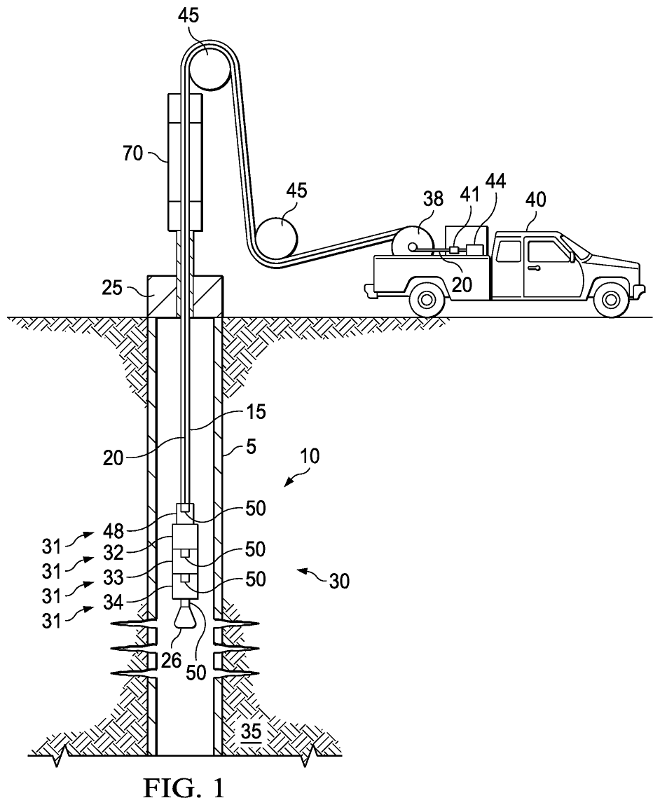

FIG. 1 is an illustration of an example logging system employing one or more compression devices, in accordance with principles of the present disclosure. Logging system 10 is shown deployed down a wellbore 5, which may be cased. The logging system 10 includes at least one logging tool 30, at least one communication line 20 such as a fiber optic line or electrical line, and at least one sensor 31. Each of the sensors 31 may employ a compression device 50 for connecting to the communication line 20, or to one another. The compression device 50 comprises a connector. The compression device 50 will be described more fully below. Data collected by sensors 31 is transmitted uphole to the surface via communication line 20. A modulator 48 may be used in communication to the surface equipment. Sensors 31 may include but are not limited to a pressure sensor 32, a flow sensor 33, a spinner 26 or a casing collar locator 34. Sensors 31 may also include fluid analyzers, gyro tools, water detection sensors, gas detection sensors, oil detection sensors, pressure sensors, acoustic sensors, spectrometers, inclinometers, temperature sensors, resistivity sensors, to name a few. The term logging tool is a tool that measures at least one parameter of the wellbore 5 or surrounding subterranean formation 35. The communication line 20 may be disposed in conduit 15 which may be a coiled tubing string to protect the communication line 20. Conduit 15 may be deployed through a wellhead 25 from a reel 38 at a vehicle 40 at the surface. Several pulleys 45 may guide the conduit 15 through a lubricator 70 to the wellhead 25 and downhole. Acquisition unit 44 may receive signals from the sensors 31 via transmitter 41.

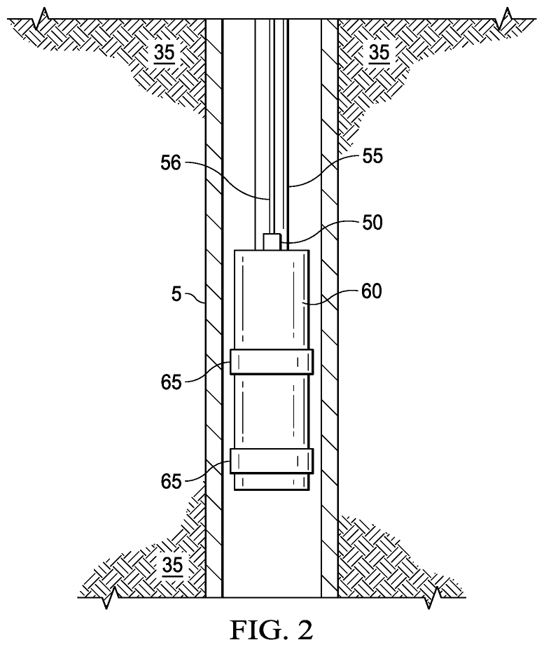

FIG. 2 is an illustration of an example setting tool employing a compression device, in accordance with principles of the present disclosure. Setting tool 60 is shown deployed downhole in a wellbore 5. A cable or string 55 may suspend the setting tool 60 for setting plugs or packers 65 at locations downhole. A compression device 50 may be used to connect a hydraulic line 56 to the setting tool 60. The hydraulic line 56 provides required pressure to the setting tool 60 for setting the plugs or packers 65. Compression device 50 provides a sealed connection between the setting tool 60 and the hydraulic line 56. Some setting tools are electric and employ an electrical line instead of hydraulic line 56. Compression device 50 may still be used to provide a sealed connection between the electric line and the setting tool 60.

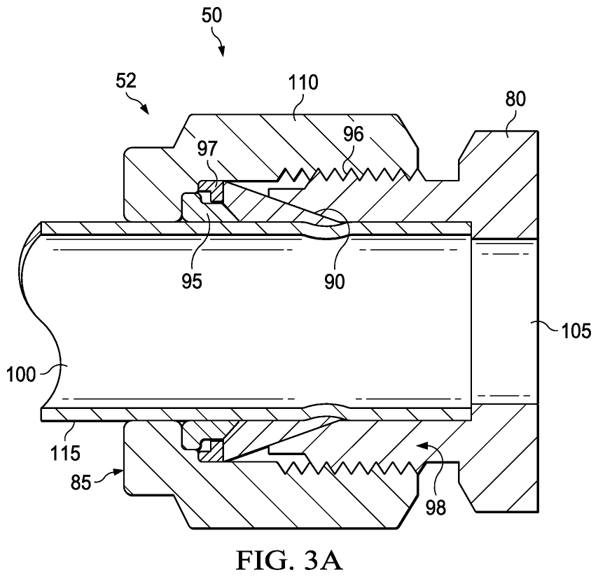

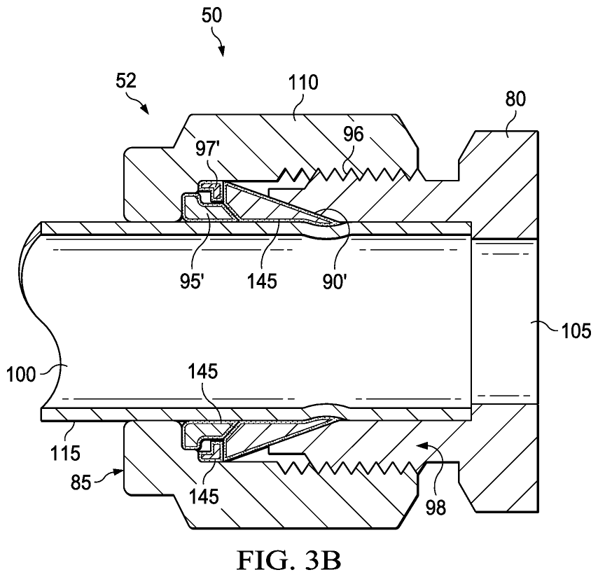

FIG. 3A is an illustration of example embodiment of a compression device, according to principles of the present disclosure. The compression device 50 is shown as a ferrule 52 that will connect a first device 115 to a second device 80. First device 115 and second device 80 are deployable downhole. A ferrule is also known as olive or a gland. Generally, a ferrule 52 can be placed under mechanical strain, typically compression, during creating of the seal between devices.

The first device 100 is shown as a tubing that is connected to the second device 80 shown as a threaded fitting 98. Generally, a fitting may be a connecting member of a downhole device such as, e.g., the logging tool 30 of FIG. 1 or the setting tool 60 of FIG. 2. However, first device 115 and second device 80 may be any downhole device or tool where a seal is required between them. The compression device 50 comprises, at least in part, an expanding metal, as described more below, to enhance sealing of the compression device.

Ferrule 52 may comprise only one or may comprise a plurality of separate components including a front ferrule 90 and a back ferrule 95. In some embodiments, a third component comprising a backup ferrule 97 may be present. The expanding metal comprising one or more of the components of the ferrule 52 is squeezed between the nut 110, first device 115 and the fitting 98 of second device 80, such as by tightening using an appropriate tool such as a wrench for tightening the nut 110. The nut 110 and the fitting 98 may comprise a metal 85 such as steel, copper, or aluminum, for example. The nut 110 and the fitting 98 may be threaded 96 to permit compression of the nut 110 against or with the fitting 98 and compression device 50. The expanding metal of the one or more components 90, 95, 97 helps to close any gap by expanding if there is a leak of a wellbore fluid thereby counteracting the leak by filling the gap. The wedge-shaped components 90, 95 assist in tightening by imparting tightening forces against the nut 110, first device 115 and the fitting 98 of second device 80. The first device is shown with a hollow passageway 100 that mates with a suitable passageway 105 of the second device 80 to permit flow of fluids as needed supporting the operational goal of the downhole devices. Any one or more of components 90, 95, 97 may comprise an expanding metal.

Expanding metal is better than an elastomer compression device because the elastomer often does not allow sufficient torque to be imparted into or onto the ferrule. The pre-expanded metal allows for application of substantially more torque as compared to an elastomer type compression device.

Moreover, as an example, if a tubing, e.g., first device 115, is mechanically manipulated while in service, then a traditional compression with no expanding metal fitting might leak. The expanding metal ferrule 52, on the other hand will re-heal, sealing any leak. Any fluid that might pass by a damaged ferrule will chemically react with the expanding metal causing physical expansion for sealing the leak. There is a great appeal for using the expanding metal as a back ferrule or a backup ferrule. Further, the expanding metal can also expand to fill and seal any damage in the first device 115 or the second device 80 in the sealing location by expanding to fill any scratches or pits or other damage in the device material in the sealing areas.

Expanding metal does not react while exposed to hydraulic fluid or to air. However, if there is a leak while downhole in the presence of water, then the metal of compression device 52 will expand to fill the volume of the leak. Thus, a ferrule comprising expanding metal behaves as a normal traditional ferrule under normal operation and then if necessary as a reactive expanding ferrule in the event of a leak.

Metal Hydration Chemistry

The volume of an expanding metal increases as a metal hydrates. This volume increase fills gaps and creates a sealing pressure.

Mg(OH)₂ takes about 85% more volume than the original Mg.

Ca(OH)₂ takes 32% more volume than the original Ca.

Al(OH)₂ takes about 160% more volume than the original Al.

The hydration reaction for magnesium is:

Mg+2H₂O→Mg(OH)₂+H₂

Another hydration reaction uses aluminum hydrolysis:

Al+3H₂O→Al(OH)₃+3/2 H₂

ther hydration reaction uses calcium hydrolysis:

Ca+2H₂O→Ca(OH)₂+H₂

Ca(OH)₂ is known as portlandite and is the basic ingredient of Portland cement.

Magnesium hydroxide and calcium hydroxide are considered to be relatively insoluble in water. The hydrolysis of any metal will create a metal hydroxide. In preferred embodiments, alkaline earth metals (Mg, Ca, etc.) or a transition metal (Al, etc.) are used in the hydrolysis reactions. In some embodiments, the metal hydroxide is dehydrated by the swell pressure to form a metal oxide. In some embodiments, any combination of Mg, Al, and Ca, might be used.

FIG. 3B is an example of the compression device of FIG. 3A with a coating 145 applied, according to principles of the present disclosure. In some embodiments, the expanding metal chemically reacts with downhole fluids and creates a seal in seconds, minutes or hours. The desired time-period may be achieved based on the type or types of expanding metal employed, and the type of coating selected. The coating 145 can be applied to one or more surfaces of one or more components of the compression device 50. As shown in FIG. 3B, coating 145 coats front ferrule 90′, back ferrule 95′ and backup ferrule 97′. However, the coating 145 may be used on any one or more of these components 90′, 95′, 97′, perhaps only one or only two, or portions thereof. The coating 145 may be broken during a setting or compression process. Breaking the coating 145 allows a chemical reaction of the expanding metal. The coating may be an epoxy, a polymer, a metal, a ceramic, or a glass. In one embodiment, any of the components of ferrule 52 may be coated in nickel, which when breached, allows reactions between the water-based fluid and the reactive metal. The setting process mechanically deforms one or more portions of the ferrule 52 and this stretching causes a breach or tear in the nickel coating, or other coating, that allows reactions between downhole water fluids and the underlying reactive metal. In one embodiment, the coating is a non-porous coating so that no reaction occurs prior to breaking the coating. In another coating, the coating is a porous coating so that a reaction is delayed prior to breaking the coating. A combination of coatings may be employed.

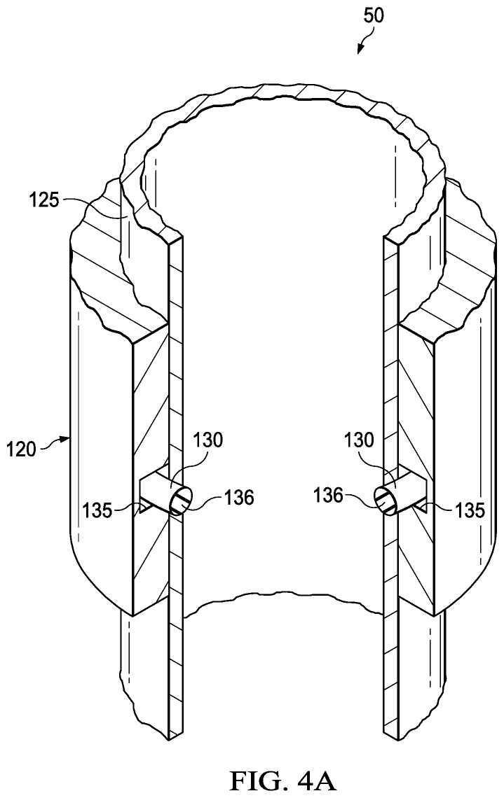

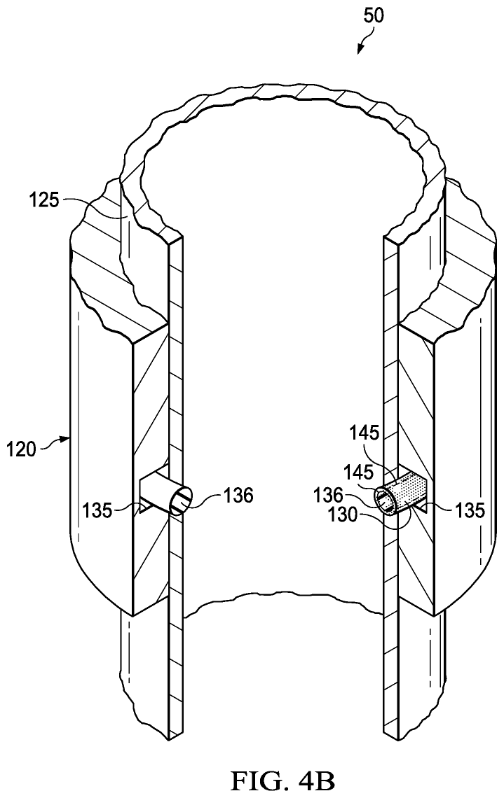

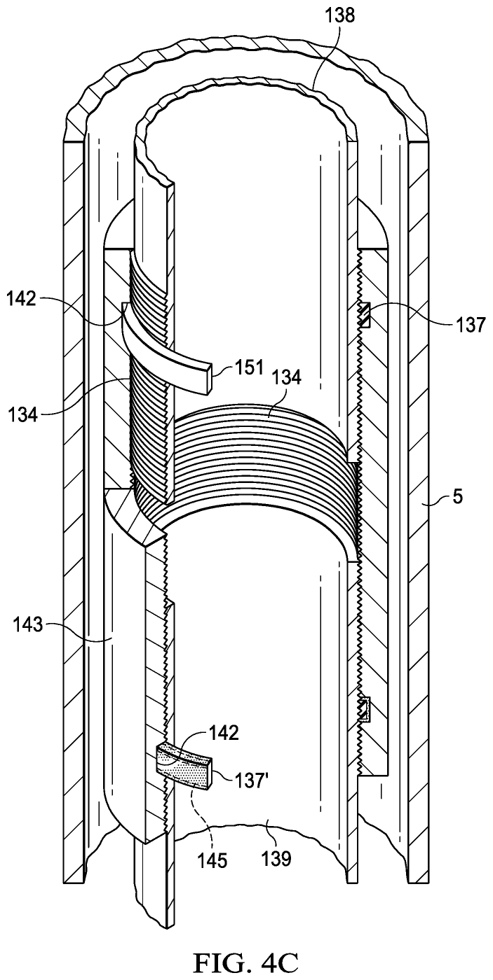

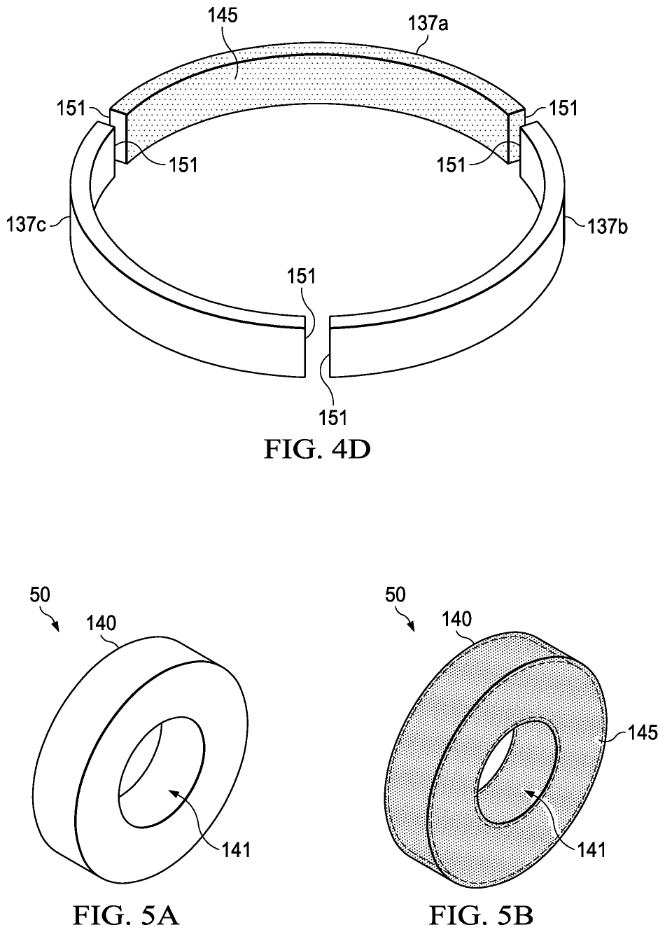

FIG. 4A is an illustration of an example embodiment of a sealing device in a cut-away perspective, according to principles of the present disclosure. A first device 120 is shown being connected to a second device 125. The devices 120, 125 shown are tubing or conduits, but could represent any other type of device that requires an O-ring type or seal ring type of seal. Devices 120, 125 may represent, but not limited to, communication lines, fiber optic lines, control lines electric lines or fluid lines. The example devices shown are actually a complete circular tube or conduit type shape, as opposed to the cut-away view shown here that exposes for illustration purposes the seal device 130, as a seal ring. Seal device 130 is a type of seal ring, which can be an O-ring, comprising an expanding metal that has sufficient expansion flexibility to permit installation within or around a circular surface of a device. A seal ring can have other shapes, and implemented with different physical schemas. One schema includes being implemented as more than one separate segment that together form a seal when positioned about a circular surface. When implemented as more than one expanding metal segment, the expanding metal segments may comprise more than two ends 136, such as four ends or six ends that may bind themselves together forming a unified single seal. In this example, a retaining compartment or groove 135 holds the O-ring comprising an expanding metal in place about the two devices 120, 125. The sealing device 130 may comprise Mg, Al or Ca, or alloys thereof, in any combination, as described above. The ends 136 of the seal ring 130 may entirely seal itself to one another when the expanding metal contacts wellbore fluids, or other fluids such as water containing hydraulic or control fluids. Alternatively, water may be applied after installation of the compression device 145 to begin the process of attaching of the pluriaty of ends 136 together by hydration.

FIG. 4B is an illustration of an example of the sealing device of FIG. 4A with a coating 145 applied, according to principles of the present disclosure. Coating 145 is shown applied to the outer circumference of the O-ring device 130 that comprises an expanding metal. Moreover, the coating 145 may be applied to the outer distal surface of one or more ends 136. In this way, the ends 136 may heal themselves after installed and exposed to downhole fluids. The coating 145 may be an epoxy, a polymer, a metal, a ceramic, or a glass. In one embodiment, the compression device 130 may be coated in nickel, which when breached, allows reactions between the water-based fluid and the reactive metal.

FIG. 4C is an example of a sealing ring, according to principles of the present disclosure. A first conduit device 138 is shown coupled to a second conduit device 139 via a coupler 143, in this example via threads 134, all within a wellbore 5. A first sealing ring 137 may be positioned about the first conduit device 138 within retaining groove 142. A second sealing ring 137′ may be positioned about the second conduit device 139 in groove 142. Both first and second seal rings 137, 137′ comprise an expandable metal. The expandable metal may comprise Mg, Al or Ca, or alloys thereof, in any combination, as described above. Coating 145 is shown applied to the outer surface of the second seal ring 137′. In embodiments, seal ring 137, 137′ may each comprise more than one separate segments that together may form a unified seal ring. Optionally, the coating 145 may be applied to one or more the cross-sectional distal ends 151 of the seal rings 137, as applications warrant. The coating 145 may be an epoxy, a polymer, a metal, a ceramic, or a glass. In one embodiment, the seal rings 137, 137′ may be coated in nickel, which when breached, allows reactions between the water-based fluid and the reactive metal. More than one type of coating may be used. Water containing fluids may be provided from the surface through the conduits 138,139 that contact one or more of the seal rings 137, 137′. The seal rings 137, 137′ may expand and heal any leaks present between the first conduit device 138 and coupler 143, the second conduit device 1389 and coupler 143, or between segments of seal ring 137, 137′ if multiple segments are used. Two seal rings 137, 137′ are now necessarily required, as only one seal ring 137 may be present, as applications warrant.

FIG. 4D is an illustration of an example of a segmented sealing ring, according to principles of the present disclosure. The segmented sealing ring 137a, 137b, 137c can be used in a same manner as sealing ring 137, 137′ of FIG. 4C, and may comprise the same expanding metals and coating options as described above in reference to the sealing ring of FIG. 4C. The plurality of segments 137a, 137b, 137c each have an end 151, and any end 151 may be coated, or not coated. There may be any number of segments such as 2, 3, 4 or more segments. The coating 145 may be an epoxy, a polymer, a metal, a ceramic, or a glass. In one embodiment, any one or all of the seal rings 137a, 137b, 137c may be coated in nickel, which when breached, allows reactions between the water-based fluid and the reactive metal. More than one type of coating may be used, perhaps different coatings on different segments. In one aspect, the ends 151 of the expanding metal segments 137a, 137b, 137c may expand to seal together forming a unified seal. Moreover, the segments 137a, 137b, 137c may also expand to seal a first conduit device 138 coupled to a second conduit device 139 via a coupler 143, such as shown in FIG. 4C.

FIG. 5A is another example embodiment of a compression device, according to principles of the present disclosure. FIG. 5B is an example of the compression device of FIG. 5A with a coating 145 applied to the expanding metal of the compression device, according to principles of the present disclosure. FIG. 5A shows a gasket or washer 140 type of compression device 50, with a hole 141 therethrough, comprising an expanding metal as previously described. A washer 140 type compression device 50 may be for creating or keeping a seal between two devices. A washer 140 may also have other forms such as having star shaped ridges or other perturbations in the opposing surfaces for added frictional hold ability while in use. Moreover, the washer could have slight curvatures in the surfaces such as to behave as a belleville spring. The curvature may be a conical shape. A coating 145 may be applied to any one or more of the surfaces, front surface, back surface, or outer circumferential surface of washer 140. The coating 145 may be an epoxy, a polymer, a metal, a ceramic, or a glass, or combinations thereof. In one embodiment, the compression device 130 may be coated in nickel, which when breached, allows reactions between the water-based fluid and the reactive metal.

The magnesium expanding metal, which can be used in any of the embodiments of the compression or sealing ring devices described herein, may comprise a magnesium alloy, an aluminum alloy, or a calcium alloy including an alloy that is alloyed with one or more of elements Al, Zn, Mn, Mg, Zr, Y, Nd, Gd, Ag, Ca, Sn, Re, in any combination. In some applications, the magnesium alloy is alloyed with a dopant that promotes corrosion such as a dopant selected from the group comprising elements Ni, Fe, Cu, Co, Ir, Au, and Pd, in any combination. The magnesium alloy may be constructed in a solid solution process where the elements are combined with molten magnesium or magnesium alloy. Alternatively, the magnesium alloy could be constructed with a powder metallurgy process.

The expanding metal compression devices described herein may be used in conjunction with any downhole device where a seal is desired or required and, in particular, a seal that can chemically heal itself while in the presence of downhole fluids or fluids provided from the surface such as, for example, hydraulic or control line fluids. The expanding metal compression devices described herein may comprise a connector or a sealing device. Example downhole devices include meters, sensors, gauges, tools, conduits, tubing, fittings, electric connectors, optical connectors to name just a few. The expanding metal compression devices herein provide significant increased compression capacity including torque capacity over traditional types of connectors employing sealing elements made of elastomers or Teflon®, for example.

Moreover, the expanding metal devices herein may be used as sealing devices or compression devices in conduits such as communication lines, fiber optic lines, control lines electric lines or fluid lines that connect to a device in a producing zone of a well. Moreover, the expanding metal devices that may be used as sealing devices or compression devices in conduits may be coated with a coating that may comprise an epoxy, a polymer, a metal, a ceramic, a glass, or combinations thereof. Moreover, the coating may comprise nickel. The embodiments herein can be employed in any situation involving one or more devices meant for downhole deployment. In some applications, more than one type of sealing device or compression device comprising expanding metal may be used in a downhole situation. Water containing fluids may be provided, for example, from the surface such as in the case of hydraulic or control line fluids to interact with the various sealing or compression devices comprising one or more expanding metals, or in certain applications, the water containing fluid may be present in the wellbore itself When deployed, the water contacts the expanding metal devices described herein so that the water causes the hydrolysis reaction of the expanding metals thereby leading to expansion of the metals to seal connections between devices, including in embodiments, between segments of seal rings.

In aspects, the following clauses provide alternate or additional description:

Clause 1: a sealing device, comprising an expanding metal that expands due to contact with water containing fluids for sealing a downhole connection in a well.

Clause 2: The sealing device of clause 1, wherein the sealing device comprises a ferrule.

Clause 3: The sealing device of clause 2, wherein the ferrule comprises a plurality of separate components.

Clause 4: The sealing device of clause 3, wherein the plurality of components comprise a front ferrule and a back ferrule.

Clause 5: The sealing device of clauses 3 or 4, wherein the plurality of components comprise a backup ferrule.

Clause 6: The sealing device of clause 1, wherein the sealing device comprises a seal ring.

Clause 7: The sealing device of claim 1, wherein the sealing device comprises a washer or a gasket.

Clause 8: The sealing device of any one of clauses 1-7, wherein the expanding metal comprises one or more of a metal or metal alloy selected from the group comprising: magnesium, aluminum, calcium, and a combination thereof.

Clause 9: The sealing device of any one of clauses 1-8, wherein the expanding metal is a magnesium alloy and is further alloyed with one or more of elements Al, Zn, Mn, Zr, Y, Nd, Gd, Ag, Ca, Sn, Re, in any combination.

Clause 10: The sealing device of any one of clauses 1-9, wherein the magnesium alloy is alloyed with a dopant selected from the group comprising Ni, Fe, Cu, Co, Ir, Au, and Pd, in any combination.

Clause 11: The sealing device of any one of clauses 1-10, further comprising a coating that covers at least one surface of the expanding metal.

Clause 12: The sealing device of any one of clauses 2-5, further comprising a coating that covers at least one surface of at least one component of the ferrule.

Clause 13: The sealing device of clauses 11 or 12, wherein the coating comprises an epoxy, a polymer, a metal, a ceramic, a glass, nickel, or combinations thereof

Clause 14: A method for providing a sealing device, comprising: connecting a sealing device between two devices, the sealing device comprising an expanding metal that expands due to contact with water containing fluids for sealing a connection.

Clause 15: The method of clause 14, further comprising lowering the two devices and sealing device down a wellbore.

Clause 16: The method of clause 14, wherein the sealing device comprises a ferrule, sealing ring, gasket or a washer.

Clause 17: The method of clause 14, wherein the expanding metal comprises one or more metals selected from the group comprising: magnesium, a magnesium alloy, aluminum, calcium, and a combination thereof

Clause 18: The method of any one of clauses 14-17, wherein the expanding metal is a magnesium alloy and is further alloyed with one or more of elements Al, Zn, Mn, Zr, Y, Nd, Gd, Ag, Ca, Sn, Re, in any combination.

Clause 19: The method of any one of clauses 17-18, wherein the magnesium alloy is alloyed with a dopant selected from the group comprising Ni, Fe, Cu, Co, Ir, Au, and Pd, in any combination.

Clause 20: The method of any one of clauses 17-19 wherein the magnesium5 alloy is constructed with a powder metallurgy process.

The examples set forth herein are merely illustrative and do not limit the scope of the disclosure. It will be appreciated that many other modifications and improvements to the disclosure herein may be made without departing from the scope of the disclosure.

We claim:

1. A sealing device, comprising:
an expanding metal that expands due to contact with water containing fluids for sealing a downhole connection in a well.

2. The sealing device of claim 1, wherein the sealing device comprises a ferrule.

3. The sealing device of claim 2, wherein the ferrule comprises a plurality of separate components.

4. The sealing device of claim 3, wherein the plurality of components comprise a front ferrule and a back ferrule.

5. The sealing device of claim 3, wherein the plurality of components comprise a backup ferrule.

6. The sealing device of claim 1, wherein the sealing device comprises a seal ring.

7. The sealing device of claim 1, wherein the sealing device comprises a washer or a gasket.

8. The sealing device of claim 1, wherein the expanding metal comprises one or more of a metal or metal alloy selected from the group comprising: magnesium, aluminum, calcium, and a combination thereof

9. The sealing device of claim 1, wherein the expanding metal is amagnesium alloy and is further alloyed with one or more of elements Al, Zn, Mn, Zr, Y, Nd, Gd, Ag, Ca, Sn, Re, in any combination.

10. The sealing device of claim 1, wherein the magnesium alloy is alloyed with a dopant selected from the group comprising Ni, Fe, Cu, Co, Ir, Au, and Pd, in any combination.

11. The sealing device of claim 1, further comprising a coating that covers at least one surface of the expanding metal.

12. The sealing device of claim 2, further comprising a coating that covers at least one surface of at least one component of the ferrule.

13. The sealing device of claim 11, wherein the coating comprises an epoxy, a polymer, a metal, a ceramic, or a glass, nickel, or combinations thereof

14. A method for providing a sealing device, comprising:
connecting a sealing device between two devices, the sealing device comprising an expanding metal that expands due to contact with water containing fluids for sealing a connection.

15. The method of claim 14, further comprising lowering the two devices and sealing device down a wellbore.

16. The method of claim 14, wherein the sealing device comprises a ferrule, sealing ring, gasket or a washer.

17. The method of claim 14, wherein the expanding metal comprises one or more metals selected from the group comprising: magnesium, a magnesium alloy, aluminum, calcium, and a combination thereof.

18. The method of claim 14, wherein the expanding metal is a magnesium alloy and is further alloyed with one or more of elements Al, Zn, Mn, Zr, Y, Nd, Gd, Ag, Ca, Sn, Re, in any combination.

19. The method of claim 17, wherein the magnesium alloy is alloyed with a dopant selected from the group comprising Ni, Fe, Cu, Co, Ir, Au, and Pd, in any combination.

20. The method of claim 17,wherein the magnesium alloy is constructed with a powder metallurgy process.
